(19) United States
(12) Patent Application Publication
(10) Pub. No.: US 2025/0014316 A1
(43) Pub. Date: Jan. 9, 2025

(54) INFORMATION PROCESSING APPARATUS CAPABLE OF PERFORMING CLUSTERING, CONTROL METHOD FOR INFORMATION PROCESSING APPARATUS, AND STORAGE MEDIUM

(71) Applicant: CANON KABUSHIKI KAISHA, Tokyo (JP)

(72) Inventor: TOMOHIRO NISHIYAMA, Tokyo (JP)

(21) Appl. No.: 18/891,419

(22) Filed: Sep. 20, 2024

Related U.S. Application Data
(63) Continuation of application No. PCT/JP2023/009777, filed on Mar. 14, 2023.

(30) Foreign Application Priority Data
Mar. 30, 2022 (JP) 2022-056179

(51) Int. Cl. G06V 10/772; G06V 10/762

(52) U.S. Cl. CPC G06V 10/772; G06V 10/762; G06V 2201/10

(57) ABSTRACT

In a case where a plurality of pieces of wide variety of dictionary data exists on, for example, a server or the like, it is possible to perform clustering of the plurality of pieces of wide variety of dictionary data.

A server apparatus 200 that is an information processing apparatus includes a server storage unit 201 configured to retain a plurality of pieces of dictionary data 310 obtained by machine learning and used for a predetermined processing, and dictionary characteristic data generated based on an input data group (a data group) 311 including a plurality of pieces of data different from the dictionary data 310 and associated with each piece of the dictionary data 310, and a clustering unit 303 configured to perform clustering with respect to the each piece of the dictionary data 310 based on the dictionary characteristic data.

### CROSS-REFERENCE TO RELATED APPLICATIONS

This application is a Continuation of International Patent Application No. PCT/JP2023/009777 filed on Mar. 14, 2023, which claims the benefit of Japanese Patent Application No. 2022-056179 filed on Mar. 30, 2022, both of which are hereby incorporated by reference herein in their entirety.

### BACKGROUND OF THE INVENTION

### Field of the Invention

The present invention relates to an information processing apparatus capable of performing clustering, a control method for the information processing apparatus, and a storage medium.

### Background Art

Conventionally, for example, a technique of performing clustering with respect to a content such as image data has been proposed. For example, Patent Literature 1 discloses an apparatus that obtains metadata such as a date and a photographing position that accompany image data as a content and performs clustering with respect to a plurality of contents based on the metadata. By performing such clustering, it is possible to organize the content.

### CITATION LIST

### Patent Literature

Patent Literature 1: Japanese Patent No. 5034706

However, in the apparatus described in Patent Literature 1, although it is possible to perform clustering with respect to specific data such as the image data, it is difficult to perform clustering of dictionary data with high abstractness such as a machine-learned trained model.

### SUMMARY OF THE INVENTION

The present invention provides an information processing apparatus capable of performing clustering of a plurality of pieces of wide variety of dictionary data in a case where the plurality of pieces of wide variety of dictionary data exists on, for example, a server or the like, a control method for the information processing apparatus, and a storage medium.

In order to achieve the above-described object, an information processing apparatus according to one aspect of the present invention includes: at least one processor, and a memory coupled to the processor storing instructions that, when executed by the processor, cause the processor to function as a retaining unit that retains a plurality of pieces of dictionary data obtained by machine learning and used for a predetermined processing, and dictionary characteristic data generated based on a data group including a plurality of pieces of data different from the plurality of pieces of dictionary data and associated with each piece of the dictionary data; and a clustering unit that performs clustering with respect to the each piece of the dictionary data based on the dictionary characteristic data.

Further features of the present invention will become apparent from the following description of exemplary embodiments with reference to the attached drawings.

### BRIEF DESCRIPTION OF THE DRAWINGS

FIG. 1 is a block diagram that shows an outline of an information processing system according to a first embodiment of the present invention.

FIG. 2 is a block diagram that shows respective hardware configurations of a smartphone and a server apparatus.

FIG. 3 is a block diagram that shows a part of a configuration of a server control unit.

FIG. 4 is a flowchart that shows a dictionary clustering processing.

FIG. 5 is a conceptual diagram of generation of dictionary characteristic data executed by a dictionary characteristic data generating unit.

FIG. 6 is a conceptual diagram of hierarchical clustering according to a second embodiment of the present invention.

FIG. 7 is a flowchart that shows a hierarchical clustering processing.

FIG. 8 is a conceptual diagram that shows a user interface (a UI) according to a third embodiment of the present invention.

FIG. 9 is a flowchart for explaining the UI shown in FIG. 8.

FIG. 10 is a diagram that shows an example of a UI that visualizes and displays characteristics of a representative dictionary for each cluster in a fourth embodiment of the present invention.

FIG. 11 is a block diagram that shows respective hardware configurations of a smartphone and a server apparatus of an information processing system according to a fifth embodiment of the present invention.

### DESCRIPTION OF THE EMBODIMENTS

Hereinafter, respective embodiments of the present invention will be described in detail with reference to the drawings. However, the configurations described in the following respective embodiments are merely examples, and the scope of the present invention is not limited by the configurations described in the respective embodiments. For example, each section constituting the present invention is able to be replaced with a section having any configuration capable of exhibiting similar functions. In addition, any component may be added. Furthermore, it is also possible to combine any two or more configurations (features) of the respective embodiments.

### First Embodiment

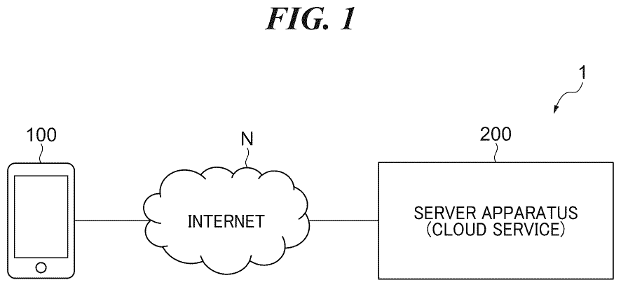

Hereinafter, a first embodiment will be described with reference to FIGS. 1 to 5. FIG. 1 is a block diagram that shows an outline of an information processing system according to the first embodiment of the present invention. As shown in FIG. 1, an information processing system 1 includes a smartphone 100 that is an information terminal and a server apparatus 200 that is an information processing apparatus. The smartphone 100 and the server apparatus 200 are communicably connected to each other via a network N. As a result, a user is able to receive various kinds of cloud services from the server apparatus 200 by using the smartphone 100. The network N is, for example, the Internet. The information terminal is not limited to the smartphone 100, and may be, for example, a digital camera or the like. The information processing apparatus is not limited to the server apparatus 200, and may be, for example, a personal computer (a PC).

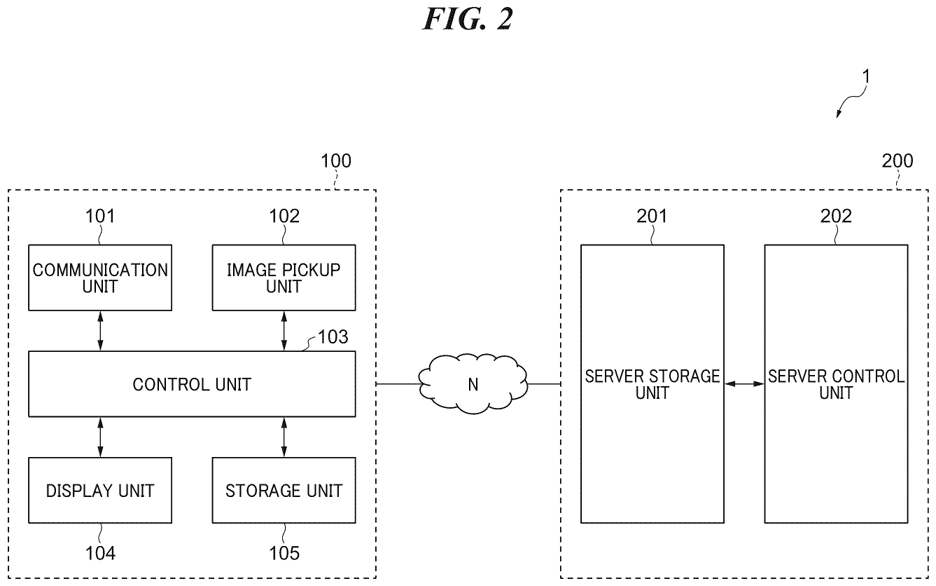

FIG. 2 is a block diagram that shows respective hardware configurations of the smartphone and the server apparatus. As shown in FIG. 2, the smartphone 100 includes a communication unit 101, an image pickup unit 102, a control unit 103, a display unit 104, and a storage unit 105. The communication unit 101 is able to communicate with the server apparatus 200 via the network N. Thus, data is able to be transmitted and received to and from the server apparatus 200. The image pickup unit 102 includes, for example, an image sensor (an image pickup device), and is able to pick up an image. The image sensor is not particularly limited, and for example, may be a charged-coupled device sensor (a CCD sensor) or a metal-oxide-semiconductor sensor (a MOS sensor). In addition, the image sensor may be a complementary metal-oxide-semiconductor sensor (a CMOS sensor) or the like. The control unit 103 includes, for example, a processor such as a central processing unit (a CPU), and controls operations of the communication unit 101, the image pickup unit 102, and the display unit 104. The display unit (a display unit) 104 includes, for example, a liquid crystal display (an LCD) and displays various kinds of images. In addition, the display unit 104 further includes a touch sensor, and also functions as an operation unit that accepts an operation from the user. The storage unit 105 includes, for example, various kinds of memories such as a semiconductor memory, a hard disk drive (an HDD), a solid state drive (an SSD), or the like. The storage unit 105 stores, for example, various kinds of programs executed by the control unit 103, images picked up by the image pickup unit 102, etc.

As shown in FIG. 2, the server apparatus 200 includes a server storage unit (a retaining unit) 201 and a server control unit (a control unit) 202. The server storage unit 201 includes, for example, a read only memory (a ROM), a random access memory (a RAM), and a hard disk or the like, and stores various kinds of programs executed by the control unit 103, and the like. These programs are not particularly limited, and examples thereof include a program for causing the control unit 103 (a computer) to execute operations of respective units and respective means of the server apparatus 200 (a control method for the information processing apparatus), and the like.

The server control unit 202 becomes capable of providing the cloud services via the network N by the control unit 103 executing the program. As will be described below, clustering is performed with respect to dictionary data on the server apparatus 200. As a result, for example, as the cloud services, it is possible to perform presentation of dictionary data suitable for the user, a search service, a download service, and the like. The server control unit 202 includes, for example, a CPU and a graphic processing unit (a GPU), and these processors perform various types of control alone or in cooperation. It should be noted that the GPU is a processor for neural network computation, and is able to perform efficient computation by processing a larger amount of data in parallel. For example, in the case of using a machine learning model that has been trained by deep learning and performing the training a plurality of times, it is possible to quickly perform the training processing by the GPU. The machine learning model is, for example, a machine learning model using a neural network in which parameters have been adjusted by an error back propagation method or the like. As a result, the server control unit 202 is able to, for example, perform deep learning that generates various parameters such as feature amounts and weights (combined weighting coefficients) for learning by itself. It should be noted that machine learning is not limited to deep learning, and may be, for example, machine learning using any machine learning algorithm such as a support vector machine, a logistics regression, a decision tree, a nearest neighbor method, or a naive Bayes method. Furthermore, the machine learning model may be a model using other than the neural network. The server control unit 202 may further include a tensor processing unit (a TPU), a neural processing unit/a neural network processing unit (an NPU), and the like. The server apparatus 200 may be configured with a server group including a plurality of server apparatuses. In this case, the server apparatus 200 is able to construct a virtual machine by using the server group and to manage the virtual machine.

### <<Dictionary Clustering Processing>>

In recent years, for example, a predetermined processing such as clustering may be performed with respect to image data, audio data, or the like. For the clustering, dictionary data that is a machine learning model (a trained model) obtained by machine learning is used. For example, in a case where clustering is performed with respect to image data, metadata such as a photographing date and a photographing position that accompany the image data is inputted into dictionary data (a machine learning model) for clustering as input data. Then, from the dictionary data, the image data is divided into predetermined clusters and is outputted as output data. As a result, it is possible to organize the image data. As described above, conventionally, it is possible to perform clustering with respect to data with high specificity such as image data, but it is considered that clustering has not been performed with respect to data with high abstractness such as dictionary data.

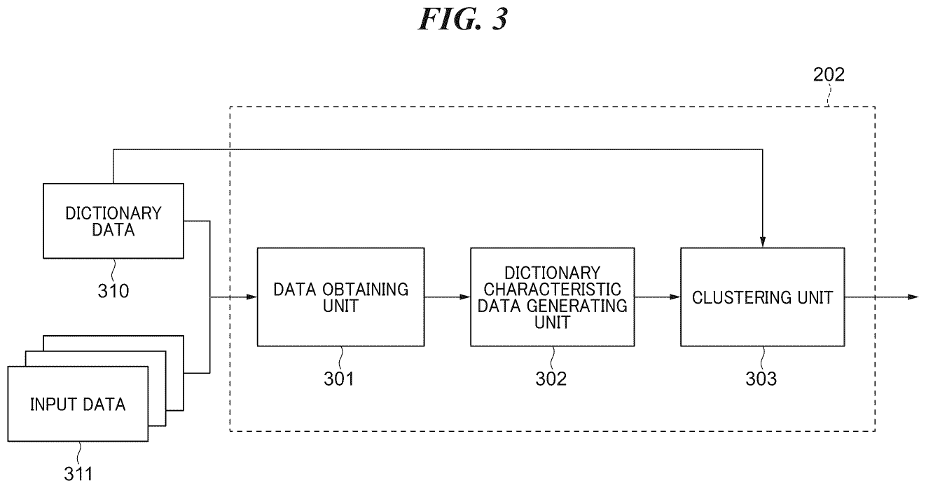

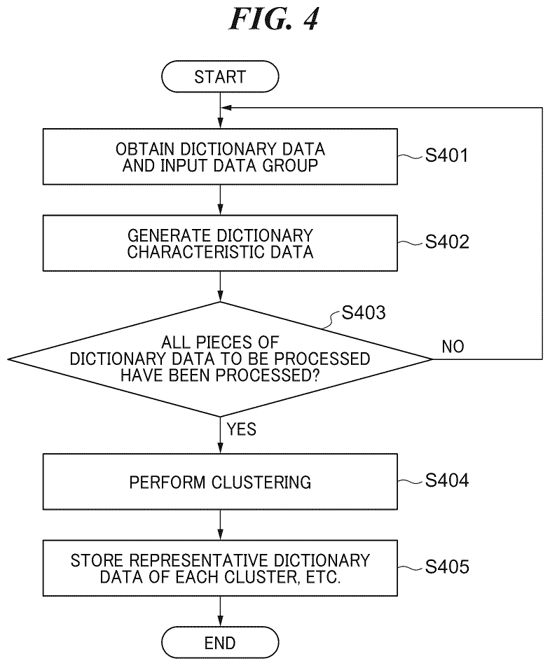

Therefore, the server apparatus 200 (the information processing system 1) is configured to be capable of performing clustering with respect to a wide variety of dictionary data. Hereinafter, this configuration and operation, that is, a clustering processing of the dictionary data executed by the server apparatus 200 will be described with reference to FIG. 3 and FIG. 4. FIG. 3 is a block diagram that shows a part of a configuration of the server control unit. As shown in FIG. 3, the server control unit 202 includes a data obtaining unit 301, a dictionary characteristic data generating unit (a generating unit) 302, and a clustering unit (a clustering unit) 303. FIG. 4 is a flowchart that shows a dictionary clustering processing.

As shown in FIG. 4, in a step S401, the server control unit 202 causes the data obtaining unit 301 to obtain dictionary data 310 and an input data group (a data group) 311 including a plurality of pieces of input data. A plurality of pieces of the dictionary data 310 and a plurality of the input data groups 311 have been retained in the server storage unit 201 in advance, and the dictionary data 310 and the input data group 311 are appropriately obtained from the server storage unit 201. It should be noted that the dictionary data 310 and the input data group 311 may be, for example, data uploaded from an external apparatus such as another server apparatus to the server apparatus 200. The dictionary data 310 is, for example, a network structure or a set of parameters obtained through machine learning such as a convolutional neural network (a CNN), a multilayer perceptron, or a decision tree. Furthermore, in the present embodiment, a plurality of pieces of image data is exemplified as the input data group 311, but the input data group is not limited thereto, and may be, for example, audio data, text data, numerical data, or the like. In addition, the input data group 311 may include, for example, one type of data among image data, audio data, text data, and numerical data, or may include a plurality of types of data among image data, audio data, text data, and numerical data. As described above, the input data group 311 is data different from the dictionary data 310. In addition, the input data group 311 represents a training data group used for machine learning of the dictionary data, or a data group for feature amount extraction for appropriately extracting features of the dictionary data.

In a step S402, the server control unit 202 operates the dictionary characteristic data generating unit 302 to generate dictionary characteristic data based on the dictionary data 310 and the input data group 311 that have been obtained in the step S401. The generation of the dictionary characteristic data will be described below. In addition, in the step S402, the server control unit 202 causes the dictionary characteristic data generating unit 302 to associate the dictionary characteristic data with the dictionary data 310, and retains it in the server storage unit 201 (a retaining step). In the present embodiment, the dictionary characteristic data is configured by a feature vector representing features of the dictionary data 310, and metadata, but is not limited thereto, and may be configured by one of the feature vector and the metadata. The metadata includes a target task of a dictionary such as subject detection, segmentation, and the like, and information of a target subject (for example, a general subject, a person, an animal, or the like). It should be noted that it is also possible to obtain the metadata from the external apparatus or the like together with the dictionary data 310. In addition, after the execution of the step S402, the input data group 311 that has become unnecessary may be deleted.

In a step S403, the server control unit 202 determines whether or not the processing in the dictionary characteristic data generating unit 302 has been completed for all pieces of the dictionary data 310 to be subjected to the clustering processing. As a result of the determination in the step S403, in a case where the server control unit 202 determines that the processing in the dictionary characteristic data generating unit 302 has been completed, the processing proceeds to a step S404. On the other hand, as the result of the determination in the step S403, in a case where the server control unit 202 determines that the processing in the dictionary characteristic data generating unit 302 has not been completed, the processing returns to the step S401, and subsequent steps are sequentially executed.

In a step S404, the server control unit 202 operates the clustering unit 303 to input the dictionary data 310 and the dictionary characteristic data that has been obtained in the step S402 to the clustering unit 303 as input data. Then, in the step S404, the server control unit 202 causes the clustering unit 303 to perform clustering based on the feature vector included in the dictionary characteristic data with respect to the dictionary data 310 (a clustering step). As a result, the dictionary data 310 is sorted into a predetermined cluster and is outputted as output data. It should be noted that, for example, clustering by existing unsupervised learning such as a K-means method or a Gaussian mixture model is able to be used for this clustering processing. In addition, the clustering unit 303 associates the cluster with the dictionary data 310 belonging to the cluster. In addition, in the step S404, the clustering unit 303 performs clustering based on the feature vector among from the feature vector and the metadata, but is not limited thereto. For example, the clustering unit 303 may perform clustering based on the metadata, or may perform clustering based on both the feature vector and the metadata. For example, in the case that clustering is performed based on the metadata, the dictionary data 310 accompanying the same metadata or similar metadata is able to be set to the same cluster. In addition, in the step S404, by inputting the input data group 311 into the dictionary data 310 and obtaining an output result, it is possible to know for what purpose the dictionary data 310 is, that is, what kind of processing is to be performed. This information is able to be used when clustering is performed.

In a step S405, the server control unit 202 causes the clustering unit 303 to specify representative dictionary data as a representative from among the dictionary data 310 belonging to each cluster. The representative dictionary data may be, for example, dictionary data that is closest to a centroid of the feature vector of each dictionary data 310 within the cluster, or dictionary data in which a sum of distances between the feature vectors within the cluster is minimized. In addition, the representative dictionary data may be dictionary data corresponding to a representative feature vector in the cluster. In addition, in the step S405, the server control unit 202 causes the clustering unit 303 to associate the cluster to which the representative dictionary data belongs with the representative dictionary data. Then, the server control unit 202 stores (retains), in the server storage unit 201, the representative dictionary data, the cluster associated with the representative dictionary data, and the dictionary characteristic data of the representative dictionary data.

It should be noted that there is a case where a change in a total number of the dictionary data 310 stored in the server storage unit 201 is detected due to addition or deletion of the number of pieces of the dictionary data 310 equal to or more than a threshold value. In this case, it is preferable for the clustering unit 303 to perform clustering again. This makes it possible to match the latest situation in the dictionary data 310. In the server apparatus 200, for example, the server control unit 202 is able to perform the function of a total number detecting unit that detects the change in the total number of the dictionary data 310.

### <<Generation of Dictionary Characteristic Data>>

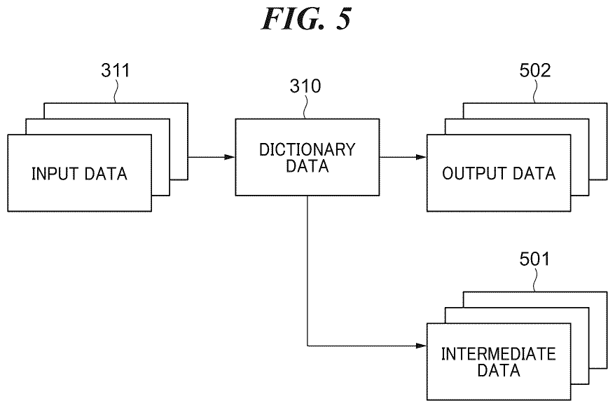

Next, generation of the dictionary characteristic data in the step S402 of the flowchart shown in FIG. 4 will be described with reference to FIG. 5. FIG. 5 is a conceptual diagram of generation of dictionary characteristic data executed by the dictionary characteristic data generating unit. As described above, the dictionary characteristic data includes the feature vector and the metadata. In FIG. 5, the input data group 311 is a plurality of pieces of input data constituting the dictionary data 310 and inputted into an input layer of a network having the input layer, an intermediate layer, and an output layer. An intermediate data group 501 is a plurality of pieces of intermediate data outputted from the intermediate layer. An output data group 502 is a plurality of pieces of output data outputted from the output layer (a final layer). Here, the intermediate data group 501 and the output data group 502 are various data such as image data, audio data, text data, and numerical data. In general, the number of parameters of the dictionary data 310 tends to be very large. Therefore, in a case where all the parameters included in the dictionary data 310 are used as the feature vector, the number of dimensions of the feature vector may also be a very large value, or it may be difficult to reflect the characteristics of the network structure of the dictionary data 310.

Therefore, the dictionary characteristic data generating unit 302 generates the feature vector representing the dictionary characteristic data and the metadata by using any one or more of the input data group, the intermediate data group, and the output data group. As a result, for example, it is possible to prevent the number of the dimensions of the feature vector from becoming a very large value, or it is possible to reflect the characteristics of the network structure of the dictionary data 310. Hereinafter, three examples of generating a feature vector will be described.

As a first example, there is a method for approximating the dictionary data 310 with a simple model (an approximate model) such as a linear model. In this case, a representative data group necessary for approximating the dictionary data 310 is selected as the input data group 311. Then, parameters of the simple model are generated as the feature vector so that a difference between the input data group 311 and the actual output data group 502 becomes a predetermined value or less. As an existing method, for example, it is possible to use local interpretable model-agnostic explanations (LIME) or the like.

As a second example, there is a method for generating (extracting) a feature vector efficiently representing features of each data group by using at least one of the input data group 311, the intermediate data group 501, and the output data group 502. Here, the input data group 311 is a training data group of the dictionary data 310, a data group for feature amount extraction, or the like. For example, principal component analysis is performed with respect to the input data group 311, and basis data of data in which a contribution rate becomes equal to or more than a predetermined value (a threshold value) is extracted. In the case of image data, since a basis image is also given by data of the same number of pixels, arrangement of a two-dimensional array (a gray image) or a three-dimensional array (a color image) is changed and converted into a vector, which can be used as a feature vector. In addition, it is also possible to extract the basis data by performing the principal component analysis with respect to different types of data groups such as the input data group 311 and the intermediate data group 501, respectively. In this case, it is possible to combine the basis data (a basis vector) of the input data group 311 and the basis data (a basis vector) of the intermediate data group 501 in a dimension direction to be a feature vector. For example, in the case that a two-dimensional vector and a three-dimensional vector are combined, a five-dimensional vector is obtained as the feature vector. As another method, an auto encoder may be used to extract a feature vector from the input data group 311, the intermediate data group 501, the output data group 502, or the above-described basis data group.

In the first example and the second example, the method for generating a feature vector as the dictionary characteristic data has been described. On the other hand, as a third example, there is a method for automatically extracting specific metadata such as a target task and a detection target of the dictionary data 310. For example, in a case where the input data group 311 is image data and the output data group 502 is configured by position coordinates of a format and a frame size, it can be determined that the dictionary data 310 is for detection or a recognition task. In addition, it is also possible to specify a subject to be detected by inputting the input data group 311 into the dictionary data 310 and recognizing an image within a frame outputted as the output data group 502. In addition, in a case where both the input data group 311 and the output data group 502 are image data and a similarity therebetween is high, it is possible to estimate that the target task is resolution conversion. It should be noted that the method for extracting the target task, the detection target, and the like of the dictionary data 310 is not limited to the above method.

As described above, in the server apparatus 200, even in a case where a plurality of pieces of wide variety of dictionary data 310 exist, the clustering unit 303 performs clustering with respect to the dictionary data 310 based on the dictionary characteristic data generated by the dictionary characteristic data generating unit 302. As a result, it becomes easy to provide cloud services such as search of a large amount of the dictionary data 310 existing on the server apparatus 200 and presentation and download of the dictionary data 310 matching a user's preference.

### Second Embodiment

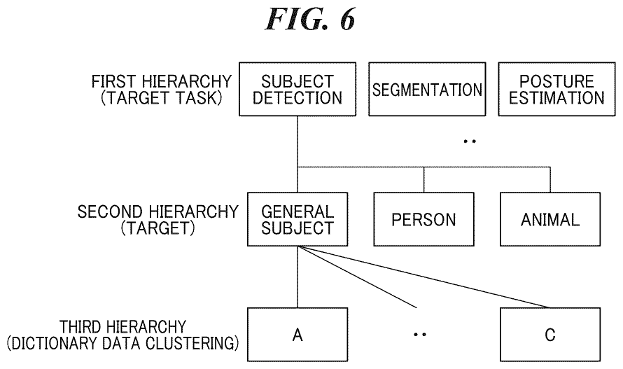

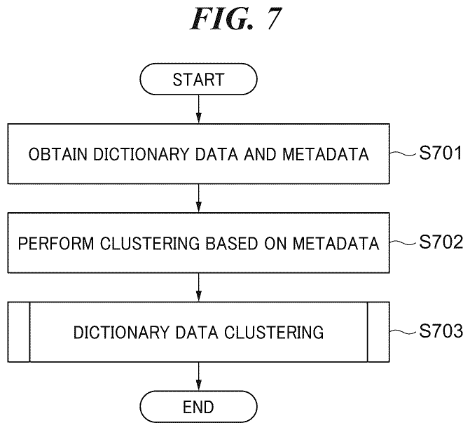

Hereinafter, a second embodiment will be described with reference to FIG. 6 and FIG. 7, but differences from the above-described embodiment will be mainly described, and descriptions of similar matters will be omitted. The present embodiment is similar to the first embodiment except that the clustering unit performs clustering in stages. In the present embodiment, it is assumed that the dictionary characteristic data includes the metadata, and is able to be roughly clustered by a target task, a target, or the like of the dictionary data. The metadata may be tagged by a dictionary data creator, or may be generated by the dictionary characteristic data generating unit 302 as described in the first embodiment.

FIG. 6 is a conceptual diagram of hierarchical clustering according to the second embodiment of the present invention. As shown in FIG. 6, clustering has a hierarchical structure including a first hierarchy, a second hierarchy, and a third hierarchy. The first hierarchy represents a target task of the dictionary data 310. The target task is not particularly limited, and examples thereof include subject detection, subject segmentation, subject posture estimation, etc. The second hierarchy represents a target of the task. The target is not particularly limited, and examples thereof include a person, an animal, or the like. The third hierarchy reflects a result obtained by performing clustering of the dictionary data 310 based on the feature vector included in the dictionary characteristic data. As a result, the dictionary data 310 is allocated to, for example, a cluster A to a cluster C. In the present embodiment, clustering of the dictionary data 310 is roughly performed by arranging a hierarchy having a meaning that can be discriminated by a human in an upper hierarchy. Furthermore, in a lower hierarchy, it is possible to efficiently perform clustering by performing abstract clustering. In addition, by performing clustering in the upper hierarchy, the accuracy of the result of clustering based on the feature vector in the lower hierarchy is also improved.

Next, a step-by-step clustering processing executed by the server control unit 202 will be described with reference to FIG. 7. FIG. 7 is a flowchart that shows a hierarchical clustering processing. It should be noted that, here, a case where the metadata accompanying the dictionary data 310 is also obtained is taken as an example, but the processing is able to be similarly performed in a case where the metadata is generated by the dictionary characteristic data generating unit 302.

As shown in FIG. 7, in a step S701, the server control unit 202 causes the data obtaining unit 301 to obtain the dictionary data 310 and the metadata accompanying the dictionary data 310.

In a step S702, the server control unit 202 operates the clustering unit 303 to perform clustering of the dictionary data 310 obtained in the same step based on the metadata obtained in the step S701. This clustering corresponds to clustering in the upper hierarchy in FIG. 6.

In a step S703, the server control unit 202 executes a series of steps (a subroutine) from the step S402 to the step S405. This processing corresponds to clustering of the lower hierarchy in FIG. 6. In the lower hierarchy, clustering based on the feature vector (the step S402 to the step S405) is performed.

### Third Embodiment

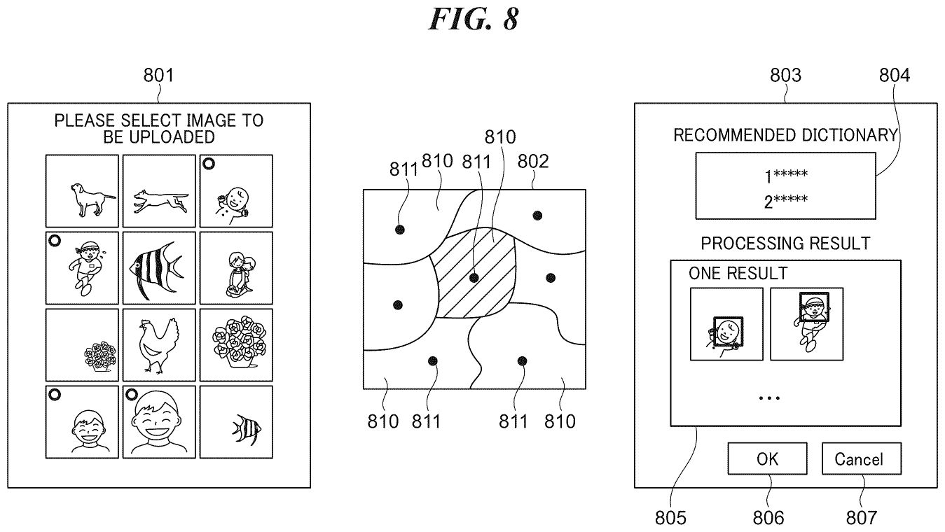

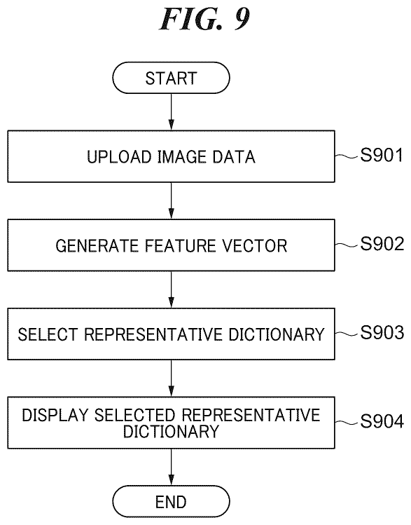

Hereinafter, a third embodiment will be described with reference to FIG. 8 and FIG. 9. FIG. 8 is a conceptual diagram that shows a user interface (a UI) according to the third embodiment of the present invention. In an example of a system shown in FIG. 8, first, the user himself/herself uploads the input data group 311 that he or she wishes to process onto the server apparatus 200. Next, the server apparatus 200 automatically searches for the dictionary data 310 suitable for the processing. Thereafter, it is downloaded as necessary. In the present embodiment, a case where image data is uploaded will be described, but data to be uploaded may be audio data, text data, or the like. Furthermore, in the present embodiment, an example in which it is assumed that the hierarchical clustering processing described in the second embodiment has been executed, and the user searches for the dictionary data 310 that recognizes a face of a smiling child with high accuracy will be described.

A screen 801 in FIG. 8 is a screen in a state where a dictionary data search application is displayed on the display unit 104. On the screen 801, “o” marks are attached to images having the face of the smiling child. It should be noted that, in a case where dictionary data for recognizing a person already exists in the smartphone 100 of the user, the dictionary data may also be uploaded. In this case, when a target task has been embedded in the metadata of the dictionary data, the server control unit 202 recognizes the metadata and specifies a cluster in the first hierarchy of the dictionary data to be searched. Furthermore, as described in the first embodiment, the server control unit 202 may estimate the target task. Further, the user may select information corresponding to the metadata from a drop-down list on the application. A conceptual diagram 802 in FIG. 8 is a diagram that conceptually shows a clustering result of the dictionary data 310 for a recognition task on the server storage unit 201. In the conceptual diagram 802, a plurality of clusters 810 is included. In each cluster 810, at least one representative dictionary 811 exists. A screen 803 in FIG. 8 is a screen transitioned on the display unit 104 after the user uploads the image data.

FIG. 9 is a flowchart for explaining the UI shown in FIG. 8. Here, the dictionary clustering processing is a processing performed based on the feature vector as described in the first embodiment.

As shown in FIG. 9, in a step S901, the server control unit 202 causes the server storage unit 201 to store the image data uploaded from the smartphone 100 via the network N.

In a step S902, the server control unit 202 causes the dictionary characteristic data generating unit 302 to generate a feature vector based on the representative dictionary 811 of each cluster 810 and the image data stored in the server storage unit 201 in the step S901.

In a step S903, the server control unit 202 compares the feature vector of the representative dictionary data used when performing clustering of the dictionary data 310 with the feature vector generated in the step S902, and selects and specifies a representative dictionary 811 having high similarity. As the similarity, for example, it is possible to use an L2 norm between feature vectors, cosine similarity, or the like. In the conceptual diagram 802, the representative dictionary 811 belonging to a hatched cluster 810 (the cluster 810 shown with diagonal lines) has been selected. It should be noted that the number of the representative dictionaries 811 selected in the step S903 is not limited to one, and may be, for example, plural.

In a step S904, the server control unit 202 transmits a result of the representative dictionary 811 selected in the step S903 to the smartphone 100 via the network N and causes the display unit 104 to display the result. The screen 803 shown in FIG. 8 is a screen on which the result of processing with the representative dictionary 811 (images that are the result obtained by clustering) is displayed on the display unit 104. The screen 803 includes a window 804, a window 805, an OK button 806, and a cancel button 807. In the window 804, a dictionary icon corresponding to each representative dictionary 811 is displayed. When the user performs a tap operation on this dictionary icon, the result of processing with the dictionary is displayed in the window 805 disposed below the window 804. As shown in FIG. 8, the result of recognizing the face of the smiling child with high accuracy is displayed in the window 805. In addition, when the user performs a tap operation on the OK button 806 in a case where there is a favorite dictionary, the representative dictionary 811 that has been selected in the window 804 is downloaded to the smartphone 100 through the network N. As described above, the user is able to quickly search for the dictionary data 310 described above that recognizes the face of the smiling child with high accuracy. On the other hand, in the case that a tap operation on the cancel button 807 has been performed, the download processing will not be executed.

It should be noted that, after the tap operation on the dictionary icon has been performed, a plurality of pieces of dictionary data 310 within the cluster 810 to which the representative dictionary 811 belongs may be further extracted, and the extraction result may be displayed on the display unit 104. In addition, as a method for selecting the dictionary icon to be displayed on the display unit 104, for example, there is a method for selecting the dictionary data 310 so that the similarity of the feature vectors is as low as possible within the cluster 810.

Next, a case where the input data group 311 is a data group for feature amount extraction will be described. With respect to the input data group 311, an image feature vector group of image data is generated in advance by using deep learning or the like. Here, in the processing corresponding to the step S902, an image feature vector group is generated by using deep learning or the like based on an image group U uploaded by the user, and an image group D in which the similarity with the image feature vector group is less than a threshold value is specified from among the input data group 311. The image group U and the image group D are image groups having different characteristics. In the step S903, the server control unit 202 selects the cluster 810 to which the representative dictionary 811 having a high recognition rate for the image group U and a low recognition rate for the image group D belongs. It should be noted that a reaction value of a heat map may be used instead of the recognition rate. With such a processing, it becomes possible to appropriately select the representative dictionary 811 that has a high recognition rate with respect to the image uploaded by the user and does not react to images having different features, that is, does not exhibit the function of performing the predetermined processing.

### Fourth Embodiment

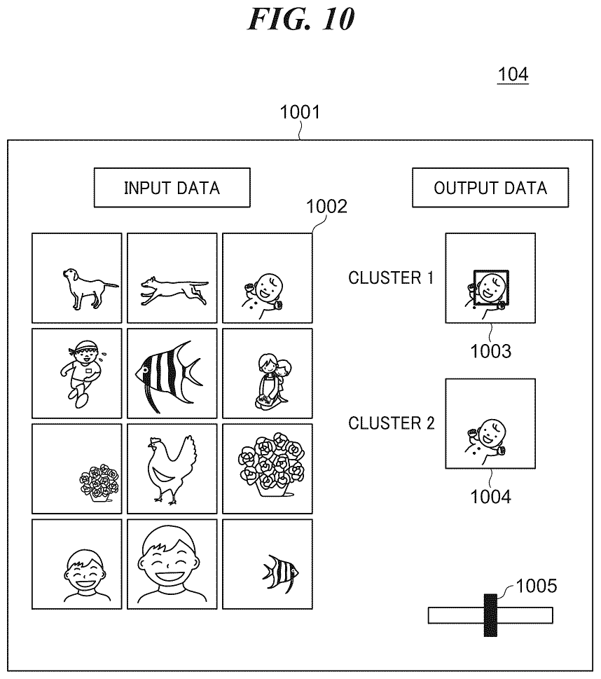

Hereinafter, a fourth embodiment will be described with reference to FIG. 10. In the present embodiment, a user interface (a UI) that allows the user to easily search for the favorite dictionary data 310 by using, for example, e-commerce (electronic commerce) or the like will be described. It should be noted that, in the present embodiment, a visualized output result from the dictionary data 310 is retained as the metadata together with each dictionary data 310, or is embedded in the dictionary characteristic data. For example, in a case where the dictionary data 310 is dictionary data for subject recognition, it is possible to visualize frame coordinates of a subject position by superimposing the frame coordinates of the subject position on an image, and the frame coordinates of the subject position are retained as the metadata.

FIG. 10 is a diagram that shows an example of a UI that visualizes and displays characteristics of a representative dictionary for each cluster in the fourth embodiment of the present invention. As shown in FIG. 10, a screen 1001 is displayed on the display unit 104 of the smartphone 100. The screen 1001 includes an input image group 1002 including a plurality of images, output results 1003 and 1004 that have been visualized by applying the representative dictionary 811 of each cluster to the input image group 1002, and a slide bar 1005. For example, a dictionary sorted into a cluster 1 is a dictionary for detecting a person (or a face of a person) with high accuracy, and a dictionary sorted into a cluster 2 is a dictionary for detecting an animal (including a person) with high accuracy. In addition, the dictionary for the cluster 1 may be a dictionary for detection, and the dictionary for the cluster 2 may be a super-resolution dictionary. As described above, the dictionary for the cluster 1 and the dictionary for the cluster 2 may have different target tasks. It should be noted that a display mode such as arrangement locations of the input image group 1002, the output results 1003 and 1004, and the slide bar 1005 on the screen 1001 is not limited to the display mode shown in FIG. 10.

The user is able to perform a tap operation on the output results 1003 and 1004 or a movement operation on the slide bar 1005. As a result, the user is able to confirm the output result with respect to each image of the input image group 1002. In addition, by visualizing the output result of the representative dictionary 811 of each cluster, the user becomes able to intuitively understand the characteristics and performance of the dictionary data 310. In addition, as the input image group 1002, some images may be extracted from training data of each representative dictionary 811 and displayed as an icon group. As an image extraction method, for example, it is possible to use a method of performing clustering of images and selecting representative images belonging to different clusters, or the like. Furthermore, instead of the output results 1003 and 1004, or together with the output results 1003 and 1004, a part of training data when performing machine learning may be displayed. In FIG. 10, for convenience of illustration, the input images of the input image group 1002 and output images which are the output results 1003 and 1004 are substantially the same in appearance. With respect to such a display mode, for example, a segmentation result of the image, a depth map estimated from the image, or the like may be additionally displayed.

### Fifth Embodiment

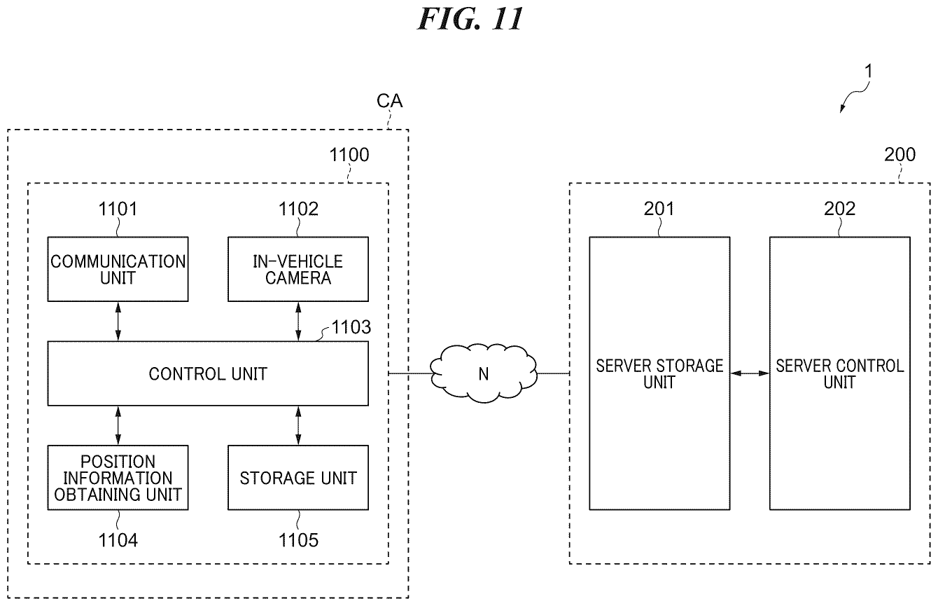

Hereinafter, a fifth embodiment will be described with reference to FIG. 11. FIG. 11 is a block diagram that shows respective hardware configurations of a smartphone and a server apparatus of an information processing system according to the fifth embodiment of the present invention. In the present embodiment, a case where an in-vehicle unit 1100 as an information terminal transmits and receives data to and from the server apparatus 200 is taken as an example, and differences from the above-described embodiments will be mainly described, and descriptions of similar matters will be omitted.

As shown in FIG. 11, the in-vehicle unit 1100 is used by being mounted on a vehicle CA. The in-vehicle unit 1100 may be mounted on the vehicle CA in advance (from the beginning), or may be mounted on the vehicle CA later. In the present embodiment, the in-vehicle unit 1100 operates with electric power supplied from a battery of the vehicle CA. It should be noted that the in-vehicle unit 1100 may be, for example, a part of an information processing apparatus as a traveling unit called “an electric vehicle pallet (an EV pallet)”, which is a type of autonomous vehicle, or may include the part of the information processing apparatus as the traveling unit. In addition, the vehicle CA may be a vehicle including an internal combustion engine as a power source, or may be a vehicle not having an automatic driving function.

The in-vehicle unit 1100 includes a communication unit 1101, an in-vehicle camera 1102, a control unit 1103, a position information obtaining unit 1104, and a storage unit 1105. The communication unit 1101 is able to communicate with the server apparatus 200 via the network N. As a result, the communication unit 1101 is able to download the clustered dictionary data 310 from the server apparatus 200 as output data or upload image(s) picked up by the in-vehicle camera 1102 or the like to the server apparatus 200 as the input data group 311. The in-vehicle camera 1102 includes an image sensor such as a CCD sensor, a MOS sensor, or a CMOS sensor, and is provided at at least one of the front and the rear of the vehicle CA. As a result, the in-vehicle camera 1102 is able to pick up an image of at least one of the front and the rear of the vehicle CA. The control unit 1103 includes a CPU and a main storage unit that stores computer programs executed by the CPU, data, etc. The CPU of the control unit 1103 executes the program loaded into the main storage unit to control the operations of the communication unit 101, the in-vehicle camera 1102, and the position information obtaining unit 1104. The storage unit 1105 is an external storage unit different from the main storage unit of the control unit 1103, and is used as a storage area that assists the main storage unit of the control unit 1103. The storage unit 1105 includes an HDD, an SSD, or the like, and stores programs executed by the CPU of the control unit 1103, data, etc.

The position information obtaining unit 1104 is a means for obtaining position information of the vehicle CA on which the in-vehicle unit 1100 is mounted. The position information obtaining unit 1104 includes a global positioning system receiver (a GPS receiver) or the like. The GPS receiver is a satellite signal receiver, and receives signals from a plurality of GPS satellites. Each of the plurality of GPS satellites is an artificial satellite that orbits around the earth. A navigation satellite system (an NSS), which is a satellite positioning system, is not limited to one in which the position information of the vehicle CA is detected by the GPS, and for example, the position information of the vehicle CA may be detected based on signals from various satellite positioning systems. The NSS is not limited to a global navigation satellite system, and may also include a quasi-zenith satellite system. It should be noted that the position information obtaining unit 1104 may include a receiver that receives a radio wave from a transmitter such as a beacon. In this case, a plurality of transmitters is disposed on a predetermined line of a parking lot, a side of the predetermined line, and the like as predetermined areas associated with the vehicle CA. In addition, the transmitter is preferably configured to periodically emit a radio wave of at least one of a specific frequency and a signal format. The means for obtaining the position information of the vehicle CA is not limited to the position information obtaining unit 1104 having the above configuration.

The in-vehicle unit 1100 uploads the position information of the vehicle CA and the image photographed by the in-vehicle camera 1102 to the server apparatus 200 via the communication unit 1101 as the input data group 311. In addition, the in-vehicle unit 1100 appropriately and automatically downloads the dictionary data 310 suitable for driving assistance or automatic driving, such as recognition of a surrounding environment of the vehicle CA, determination of a traffic condition, and monitoring of a driver, via the communication unit 1101. As a method for selecting the dictionary data 310 at the time of download, it is possible to use the method that has been described in the third embodiment. For example, in a case where it is desired to switch a dictionary having a high recognition rate of a person or a traffic sign according to a time zone (daytime or nighttime) or the weather, the communication unit 1101 uploads images of the surrounding environment. These images may be time-series data, and correspond to the image group displayed on the screen 801 of the third embodiment. For example, on the server apparatus 200, among the dictionary data 310 belonging to the cluster of an on-vehicle recognition dictionary, a cluster to which the representative dictionary 811 in which a feature vector extracted from the uploaded image group and a feature vector of the training data are closest belongs is specified. As a result, it is possible to specify a cluster to which the representative dictionary 811 that has been trained with data close to a current traffic condition belongs. Furthermore, at least one dictionary within the cluster may be selected to evaluate a matching rate and/or a reproduction rate, and the most accurate dictionary may be selected and downloaded. Examples of the method for evaluating the matching rate and/or the reproduction rate include, but are not limited to, a method of clipping only within a detection frame, performing correction of brightness, etc., and performing image recognition.

As described above, according to the present embodiment, it becomes possible to appropriately obtain the dictionary data 310 suitable for the surrounding situation from the server apparatus 200, for example, in the automatic driving, the driving assistance, or the like. It should be noted that, in the present embodiment, the image photographed by the in-vehicle camera 1102 has been described as one application example, but the present invention is also applicable to an image photographed by a monitoring camera or the like capable of performing fixed-point photographing. According to the present invention, in the case where the plurality of pieces of wide variety of dictionary data exists on, for example, the server or the like, it is possible to perform the clustering of the plurality of pieces of wide variety of dictionary data.

The disclosure of the present embodiment includes the following configurations, a method, and a program.

(Configuration 1) An information processing apparatus including:
at least one processor; and
a memory coupled to the processor storing instructions that, when executed by the processor, cause the processor to function as:
a retaining unit that retains a plurality of pieces of dictionary data obtained by machine learning and used for a predetermined processing, and dictionary characteristic data generated based on a data group including a plurality of pieces of data different from the plurality of pieces of dictionary data and associated with each piece of the dictionary data; and
a clustering unit that performs clustering with respect to the each piece of the dictionary data based on the dictionary characteristic data.

(Configuration 2) The information processing apparatus described in configuration 1,
in which the dictionary characteristic data includes at least one of a feature vector representing features of the each piece of the dictionary data and metadata, and
the clustering unit performs the clustering based on at least one of the feature vector and the metadata.

(Configuration 3) The information processing apparatus described in configuration 1 or 2,
in which the each piece of the dictionary data is divided into a plurality of clusters by the clustering, and
the clustering unit associates each of the clusters with the dictionary data belonging to the each of the clusters.

(Configuration 4) The information processing apparatus described in any one of configurations 1 to 3,
in which the each piece of the dictionary data is divided into a plurality of clusters by the clustering,
the clustering unit specifies representative dictionary data as a representative from among the dictionary data belonging to the each of the clusters and associates the cluster to which the representative dictionary data belongs with the representative dictionary data, and
the retaining unit is capable of retaining the representative dictionary data and the cluster associated with the representative dictionary data.

(Configuration 5) The information processing apparatus described in any one of configurations 1 to 4, in which
the instructions, when executed by the processor, cause the processor to further function as a total number detecting unit that detects a change in a total number of the dictionary data retained in the retaining unit, and
in which the clustering unit performs the clustering again in a case that the change in the total number of the dictionary data has been detected by the total number detecting unit.

(Configuration 6) The information processing apparatus described in any one of configurations 1 to 5, in which the clustering unit performs the clustering in stages.

(Configuration 7) The information processing apparatus described in configuration 6,
in which the dictionary characteristic data includes a feature vector representing features of the each piece of the dictionary data and metadata, and
when performing the clustering in stages, the clustering unit performs clustering in an upper hierarchy based on the metadata and performs clustering in a lower hierarchy based on the feature vector.

(Configuration 8) The information processing apparatus described in any one of configurations 1 to 7, in which the data group includes at least one of image data, audio data, text data, and numerical data.

(Configuration 9) The information processing apparatus described in any one of configurations 1 to 8, in which the instructions, when executed by the processor, cause the processor to further function as a generating unit that generates the dictionary characteristic data.

(Configuration 10) The information processing apparatus described in configuration 9, in which the generating unit generates the dictionary characteristic data based on at least one of input data constituting the dictionary data and inputted into an input layer of a network having the input layer, an intermediate layer, and an output layer, intermediate data outputted from the intermediate layer, and output data outputted from the output layer.

(Configuration 11) The information processing apparatus described in configuration 10,
in which the dictionary data is a machine learning model, and
the generating unit sets parameters of an approximate model approximating the machine learning model, in which a difference between the input data and the output data is equal to or smaller than a predetermined value, as the dictionary characteristic data.

(Configuration 12) The information processing apparatus described in configuration 10, in which the generating unit performs principal component analysis with respect to at least one piece of data among the input data, the intermediate data, and the output data, and sets, as the dictionary characteristic data, basis data of data in which a contribution rate becomes equal to or more than a predetermined value.

(Configuration 13) The information processing apparatus described in any one of configurations 1 to 12, in which the information processing apparatus is communicably connected to an information terminal via a network.

(Configuration 14) The information processing apparatus described in configuration 13,
in which the information terminal includes a display unit that displays an image, and
the instructions, when executed by the processor, cause the processor to further function as a control unit that performs control to cause the display unit to display a result obtained by the clustering as the image.

(Method 1) A control method for an information processing apparatus, the control method including:
a retaining step of retaining a plurality of pieces of dictionary data obtained by machine learning and used for a predetermined processing, and dictionary characteristic data generated based on a data group including a plurality of pieces of data different from the plurality of pieces of dictionary data and associated with each piece of the dictionary data; and
a clustering step of performing clustering with respect to the each piece of the dictionary data based on the dictionary characteristic data.

### (Program 1)

A non-transitory computer-readable storage medium storing a program for causing a computer to execute a control method for an information processing apparatus,
the control method comprising:
a retaining step of retaining a plurality of pieces of dictionary data obtained by machine learning and used for a predetermined processing, and dictionary characteristic data generated based on a data group including a plurality of pieces of data different from the plurality of pieces of dictionary data and associated with each piece of the dictionary data; and
a clustering step of performing clustering with respect to the each piece of the dictionary data based on the dictionary characteristic data.

### Other Embodiments

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

1. An information processing apparatus comprising:
at least one processor; and
a memory coupled to the processor storing instructions that, when executed by the processor, cause the processor to function as:
a retaining unit that retains a plurality of pieces of dictionary data obtained by machine learning and used for a predetermined processing, and dictionary characteristic data generated based on a data group including a plurality of pieces of data different from the plurality of pieces of dictionary data and associated with each piece of the dictionary data; and
a clustering unit that performs clustering with respect to the each piece of the dictionary data based on the dictionary characteristic data.

2. The information processing apparatus according to claim 1,
wherein the dictionary characteristic data includes at least one of a feature vector representing features of the each piece of the dictionary data and metadata, and
the clustering unit performs the clustering based on at least one of the feature vector and the metadata.

3. The information processing apparatus according to claim 1,
wherein the each piece of the dictionary data is divided into a plurality of clusters by the clustering, and
the clustering unit associates each of the clusters with the dictionary data belonging to the each of the clusters.

4. The information processing apparatus according to claim 1,
wherein the each piece of the dictionary data is divided into a plurality of clusters by the clustering,
the clustering unit specifies representative dictionary data as a representative from among the dictionary data belonging to the each of the clusters and associates the cluster to which the representative dictionary data belongs with the representative dictionary data, and
the retaining unit is capable of retaining the representative dictionary data and the cluster associated with the representative dictionary data.

5. The information processing apparatus according to claim 1, wherein
the instructions, when executed by the processor, cause the processor to further function as a total number detecting unit that detects a change in a total number of the dictionary data retained in the retaining unit, and
the clustering unit performs the clustering again in a case that the change in the total number of the dictionary data has been detected by the total number detecting unit.

6. The information processing apparatus according to claim 1,
wherein the clustering unit performs the clustering in stages.

7. The information processing apparatus according to claim 6,
wherein the dictionary characteristic data includes a feature vector representing features of the each piece of the dictionary data and metadata, and
when performing the clustering in stages, the clustering unit performs clustering in an upper hierarchy based on the metadata and performs clustering in a lower hierarchy based on the feature vector.

8. The information processing apparatus according to claim 1,
wherein the data group includes at least one of image data, audio data, text data, and numerical data.

9. The information processing apparatus according to claim 1, wherein
the instructions, when executed by the processor, cause the processor to further function as a generating unit that generates the dictionary characteristic data.

10. The information processing apparatus according to claim 9,
wherein the generating unit generates the dictionary characteristic data based on at least one of input data constituting the dictionary data and inputted into an input layer of a network having the input layer, an intermediate layer, and an output layer, intermediate data outputted from the intermediate layer, and output data outputted from the output layer.

11. The information processing apparatus according to claim 10,
wherein the dictionary data is a machine learning model, and
the generating unit sets parameters of an approximate model approximating the machine learning model, in which a difference between the input data and the output data is equal to or smaller than a predetermined value, as the dictionary characteristic data.

12. The information processing apparatus according to claim 10,
wherein the generating unit performs principal component analysis with respect to at least one piece of data among the input data, the intermediate data, and the output data, and sets, as the dictionary characteristic data, basis data of data in which a contribution rate becomes equal to or more than a predetermined value.

13. The information processing apparatus according to claim 1,
wherein the information processing apparatus is communicably connected to an information terminal via a network.

14. The information processing apparatus according to claim 13,
wherein the information terminal comprises a display unit that displays an image, and
the instructions, when executed by the processor, cause the processor to further function as a control unit that performs control to cause the display unit to display a result obtained by the clustering as the image.

15. A control method for an information processing apparatus, the control method comprising:
a retaining step of retaining a plurality of pieces of dictionary data obtained by machine learning and used for a predetermined processing, and dictionary characteristic data generated based on a data group including a plurality of pieces of data different from the plurality of pieces of dictionary data and associated with each piece of the dictionary data; and
a clustering step of performing clustering with respect to the each piece of the dictionary data based on the dictionary characteristic data.

16. A non-transitory computer-readable storage medium storing a program for causing a computer to execute a control method for an information processing apparatus,
the control method comprising:
a retaining step of retaining a plurality of pieces of dictionary data obtained by machine learning and used for a predetermined processing, and dictionary characteristic data generated based on a data group including a plurality of pieces of data different from the plurality of pieces of dictionary data and associated with each piece of the dictionary data; and
a clustering step of performing clustering with respect to the each piece of the dictionary data based on the dictionary characteristic data.
